(19) United States
(12) Patent Application Publication
(10) Pub. No.: US 2009/0070877 A1
(43) Pub. Date: Mar. 12, 2009

(54) METHOD FOR SECURING STREAMING MULTIMEDIA NETWORK TRANSMISSIONS

(76) Inventors: Carol Davids, Lisle, IL (US); Gary Dorst, Chicago, IL (US); Ken Kousky, Freeland, MI (US); Paul Raymond Sand, Woodridge, IL (US); Gene Yahnes, Niles, IL (US)

Correspondence Address: PAULEY PETERSEN & ERICKSON, 2800 WEST HIGGINS ROAD, SUITE 365, HOFFMAN ESTATES, IL, 60195, US

(21) Appl. No.: 12/272,423

(22) Filed: Nov. 17, 2008

Related U.S. Application Data
(63) Continuation-in-part of application No. 11/641,375, filed on Dec. 18, 2006.

(51) Int. Cl. H04L 9/00

(52) U.S. Cl. 726/23

(57) ABSTRACT

A method of and apparatus for securing against an unauthorized transmission within an authorized transmission from a sending data processor to a receiving data processor. The transmission is stimulated to elicit a predictable response from the receiving data processor. Upon the observance or absence of the predictable response, the transmission is determined as being potentially unauthorized. The method of this invention can be implemented in network administrator middleboxes such as firewalls.

### CROSS REFERENCE TO RELATED APPLICATION(S)

This patent application is a continuation-in-part of U.S. patent application Ser. No. 11/641,375, filed on 18 Dec. 2006. The co-pending parent application is hereby incorporated by reference herein in its entirety and is made a part hereof, including but not limited to those portions which specifically appear hereinafter.

### BACKGROUND OF THE INVENTION

This invention relates generally to securing against the theft of data or other service fraud by hiding the data within an electronic message or transmission, such as an otherwise authorized multimedia transmission, such as Voice over Internet Protocol (VoIP) transmissions or Internet Protocol Television (IPTV).

Detecting unwanted events in a network by Network Behavior Analysis (NBA) is a way to uncover security policy violations by employees or other insiders and attacks from outsiders. Detections of these events allow for remediation to protect a company's network from compromise or from the theft of important electronically stored information. The way an NBA works is to train the NBA system by exposing it to usual network traffic so that the system learns what is expected behavior. Then the NBA system is activated. While activated, the NBA system identifies traffic that does not conform to the learned expected behavior. A serious deficiency of these NBA systems is that unexpected traffic may appear to be expected if it approximates the learned behavior of the network. A problem addressed by one embodiment of this invention is that VoIP protocols can be used to transmit data rather than voice to steal information from a company or to inject malicious executables into the company's network. As NBA systems would be trained to expect VoIP traffic, the data transmissions are not identified as suspect.

Recently VoIP has been growing in popularity. VoIP provides many benefits including the capability for large conference sizes with the addition of a conference gateway, the capability for coordination among numbers of individuals, providing a single-cross organization, cross-boundary communications medium. VoIP is rapidly deployable and provides a single connection medium for voice, data, and video. Many companies and even the Federal government are adopting VoIP and moving to an IP network for converged communications.

However, VoIP has a significant security issue. Transmission channel access cannot be fully controlled or blocked to be fully operational, usable, and compatible with current telephony. Also, because everything is “data,” conventional detection (similar to virus and spyware detection programs) has major difficulties distinguishing between voice, video, or other data information found in the transmissions while maintaining desired real-time performance. Unlike already well-known virus and spyware, there are no clear distinguishing markers or signatures. Data and executables move without inspection through the VoIP media port in firewalls. Deep packet inspection (DPI) of the transmission is generally impossible because the introduced delay would be unacceptable by damaging the quality of the real-time transmission. Thus data, executables, spy programs, and/or Trojan horses, for example, can generally be smuggled in or out without inspection or possibility of inspection.

Currently, VoIP often provides an unchecked channel to the migration of computer data and executables. VoIP provides hackers, thieves, spies, and computer system terrorists with an unchecked, open channel to steal data, e.g., files and databases, plant executables with the means for unchecked distribution to other systems, send a command to trigger a malware such as Denial of Service (DOS) attack previously planted via the VoIP or other means, and/or destroy computer system infrastructure. Governments and companies that have switched to VoIP for the significant benefits VoIP provides could find that a hacker, spy, or terrorist could have stolen valuable information or planted an executable that could damage or destroy computer systems.

Furthermore, Internet provider companies have placed more of an emphasis on those few users who utilize large amounts of bandwidth. Service providers have begun to implement fees for users who use amounts of bandwidth that are way beyond the average user. As such fees are put into place, Internet users may look for ways to bypass those fees. One such way would be to transmit data through a fee-free, unlimited VoIP connection. This service fraud would be difficult or impossible to detect while maintaining the quality of service (QoS) or integrity of the VoIP service.

Detection of hidden data in real-time within VoIP or other streaming media transmissions is difficult because inspections of the transmissions consume too much time and delay the transmission. A key requirement for an application that creates or processes streams of audio and/or video is that the delay be kept to a minimum, in order to recreate the real-time experience. Detecting hidden data in a media stream is even more difficult when the stream is encrypted.

There is a need for a way to secure against the smuggling of unauthorized transmission within an authorized transmission, such as a multimedia stream or a VoIP call.

### SUMMARY OF THE INVENTION

A general object of the invention is to provide method of determining a type or content of a transmission that is encrypted or otherwise not amenable to real-time deep packet inspection. The invention is useful in identifying types of data and/or preventing the smuggling of unauthorized transmissions in authorized network transmissions, such as a VoIP call or other multimedia transmission.

A more specific objective of the invention is to overcome one or more of the problems described above.

The general object of the invention can be attained, at least in part, through a method of determining a type or content of a transmission from a sending data processor to a receiving data processor, where at least one of the sending data processor or the receiving data processor is within a protected network. The method of one embodiment includes stimulating, e.g., automatically with a computer, the protected network and/or a transmission to elicit a predictable response from the receiving data processor, and determining the type or content of the transmission based upon an observation or absence of the predictable response.

The method of this invention can be used to determine a type or content of encrypted messages. Whereas the encrypted message is not easily inspected, the stimulation and predictable response can be used to determine whether the encrypted transmission included a particular type of data, such as structured data versus multimedia data.

The method of this invention prevents the hiding of computer data or executables behind the headers of, for example, RTP protocol data units, i.e., packets or datagrams, that are typically created for VoIP or other multimedia transmissions. Generally, the data behind these headers is a group of bytes, i.e., payload or body, that represent voice or video. The payloads are played at the receiving end as a stream of audio and/or video. The method of this invention prevents someone from hiding computer data or an executable where the voice and/or video is or should be.

Unlike known techniques, the method of this invention does not require the inspection of the packets behind the headers. As discussed above, such inspection undesirably causes too much delay in multimedia streams. The method of this invention can be used in a manner that does not add human-appreciable delay. Also, unlike the method of this invention, known techniques for inspection of the body of the RTP message typically involve considerable amounts of processing power and decision-making.

The present invention includes a method for processing and altering the data packets of an authorized multimedia transmission in such a way that they can be played back to the receiver without noticeable degradation in the quality. Characteristics of audio, video, and the codecs used to encode them allow for such an alteration. When an unauthorized command or data file, such as a spreadsheet, database, or executable, is disguised or hidden within a media transmission, the alteration also affects and renders that command or file useless, i.e., it cannot be opened or executed by the receiving data processor.

The invention further provides an apparatus for determining a type or content of transmission from a sending data processor to a receiving data processor. The apparatus includes a processor and a storage medium in combination with the processor and storing a program for controlling the processor. The processor is operative with the program to introduce a stimulation to one of the protected network or a transmission from within the protected network to elicit a predictable response from the receiving data processor. In one embodiment, a computer readable medium is encoded with instructions that are executable on a middlebox of the protected network for performing the method of this invention

The apparatus and method of this invention can be added to firewalls, intrusion and/or extrusion detection and prevention systems (IDS, IPS, etc.), RTP gateways, proxies, conference servers or mixers, transcoders, application layer gateways (ALG), session border controllers (SBC), or other middleboxes, and enables them to prevent the misuse of a media stream for smuggling data or executables in or out of a device, e.g., computer or other multimedia device, or network. The method of this invention is particularly appropriate for encrypted media streams, as there often is no simple way to inspect encrypted content.

As used herein, references to “structured data” are to be understood to refer to data that requires a digital integrity for utilization or execution. As a comparison, streaming multimedia may be interrupted to some extent upon losing integrity, but the multimedia data still can display the portions received by the recipient data processor.

As used herein, references to “middlebox” are to be understood to refer to an intermediate device or software in a network, such as the Internet, that provides transport policy enforcement.

Further, references herein to “RTP” or “real-time transport protocol” are to be understood to refer to an Internet-standard protocol for the transport of real-time data, including audio and video. RTP is used in voice-over-IP architectures, for videoconferencing, media-on-demand, and other applications. RTP is a packet based communication protocol that adds timing and sequence information to each packet to allow the reassembly of packets to reproduce real time audio and video information. RTP is a transport used in some IP audio and video environments. RTP is designed to provide end-to-end network transport functions for applications transmitting real-time data, such as audio, video, or simulation data, over multicast or unicast network services.

References herein to “UDP” or “user datagram protocol” are to be understood to refer to a communication protocol that coordinates the one-way transmission of data in a packet data network. The UDP protocol utilizes the division of files or blocks of data information into packets that are transmitted during a communication session using Internet Protocol (IP) addressing. This allows the receiving end to receive and, with its best effort, recreate the original data file or block of data that was transmitted. UDP is used for real-time audio and video traffic where lost packets are simply ignored, because there is no time to retransmit.

A “packet” includes three elements. The first element is a header, which marks the beginning of the packet. The second element is a data area or payload, which contains the information to be carried in the packet. The third element of a packet is a trailer, which marks the end of the packet.

References herein to “back channel” or “return channel” are to be understood to refer to the physical way that an end-user (e.g., receiving computer) is able to send information, requests and/or demands back to the network and/or the sending computer. The back channel is a channel in the opposite direction to the main or front channel.

Other objects and advantages will be apparent to those skilled in the art from the following detailed description taken in conjunction with the appended claims and drawings.

### BRIEF DESCRIPTION OF THE DRAWINGS

FIG. 1 is a simple schematic that illustrates a system for implementing the method of one embodiment of this invention.

FIG. 2 is a simple schematic that illustrates a system for implementing the method of another embodiment of this invention.

FIG. 3 is a schematic overview that illustrates a system for implementing the method of yet another embodiment of this invention.

FIG. 4 is a schematic overview that illustrates a system for implementing the method of still yet another embodiment of this invention.

### DETAILED DESCRIPTION OF THE INVENTION

The present invention provides a method of determining a type or content of a transmission from a sending data processor to a receiving data processor. The invention can be used to find and/or interfere with the sending of unauthorized transmissions, such as structured data within a Voice or Video over Internet Protocol (collectively, “VoIP”) transmission, or may simply be used to identify the presence of structured data in the transmission. The transmission may be sent from or to a protected network, and can be disguised in or disguised as an authorized type of transmission, such as VoIP transmission. This invention also contemplates hardware and software for implementing the method. Embodiments of the invention are described below with particular reference to VoIP transmissions; however the method of this invention is not intended to be so limited. The method of this invention can be applied to, for example, streaming audio or video or other network transmissions.

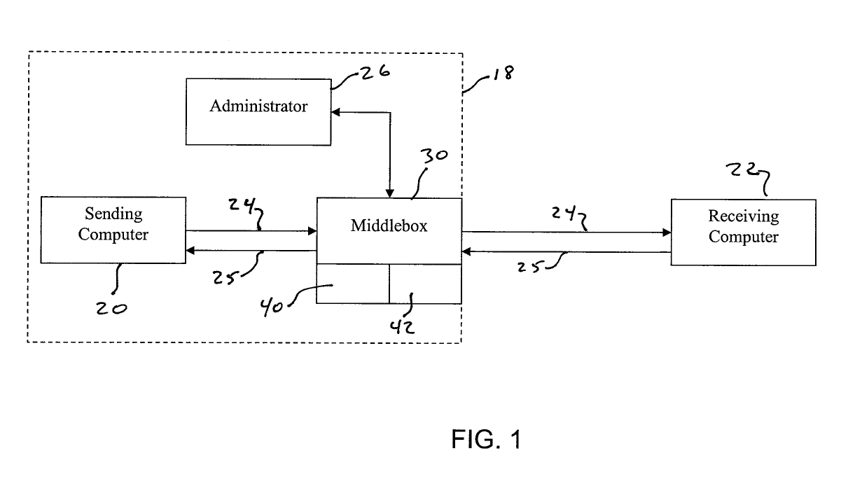

FIG. 1 is a simple schematic that illustrates the implementation of the method of one embodiment of this invention. In FIG. 1, a protected network is generally illustrated by a dashed box 18. Within the protected network 18 is a sending data processor 20 (e.g., a computer) that is authorized to make transmission to outside of the protected network 18. In the illustration of FIG. 1, the sending data processor 20 is sending a transmission to a receiving data processor 22.

The transmission is sent on a forward or front channel 24. The transmission passes out of the protected network through a middlebox 30 in combination with a network server 26 of an administrator of network 18. The middlebox 30 is, incorporates, or operates in combination with an apparatus for stimulating the protected network 18 and/or the transmission to elicit a predictable response from the receiving data processor 22. From the observation or absence of the predictable response, the middlebox 30 and/or protected network 18 can determine the type or content of the transmission (e.g., whether is it structured data or streaming multimedia) and/or whether the transmission is unauthorized.

The middlebox 30 can be any apparatus for monitoring and stimulating transmissions from the sending data processor 20 to the receiving data processor 22, or vice versa. In one embodiment of this invention, such an apparatus includes a processor 40 and a computer readable storage medium 42 in combination with the processor 40. The storage medium 42 can be any suitable medium, such as a hard drive, flash drive or optical storage medium, for storing a program for controlling the processor 40. The computer readable medium 42 contains code with instructions for performing the stimulating of the protected network and/or a transmission and determining the type or content of the transmission and/or whether the transmission is unauthorized based upon an observation or absence of the predictable response from the receiving data processor 22. The processor 40 is operative with the program on storage medium 42 to introduce the stimulation. The processor 40 is further operative with the program to determine the type or content of the transmission 24 and/or whether the transmission 24 is unauthorized based upon an observation or absence of the predictable response. The program on the medium 42 can include code to perform any aspect of the method of the invention discussed herein, such as monitoring the back channel 25 or adapting or modifying the stimulation to reduce false positives. Exemplary middle boxes include, without limitation, firewalls, conference servers, gateways, proxies, or routers.

The stimulation can be any addition, subtraction, or other modification or alteration of the transmission. The stimulation is such that there would be a predicted or expected response (e.g., either an actual response or a lack of response) depending on the type of unexpected transmission, the type of stimulation, and whether or not there is any other type of transmission hidden within the authorized transmission. As an example, if the stimulation includes a patterned or random removal of data packets from a VoIP transmission, no response may be expected if the transmission is truly a voice transmission, as the alteration is designed to have a minimal or undetectable affect on the voice transmission for the recipient. However, if the VoIP transmission includes or is in fact an unauthorized data transmission, a possible predicted response can be receiving a request for a retransmission.

In one embodiment of this invention, the protected network is stimulated with noise. Noise may be introduced in various forms that most basically include introduction of any sort of error in the transmission, including changing single bits or losing entire packets. The amount and type of noise is sufficiently small to not interfere with an authorized transmission, such as a VoIP transmission, and there would be no expected response from the receiving data processor 22 as a result of noise in a VoIP transmission. However, if the transmission contains unauthorized or unexpected data, or is a structured data transmission disguised as a VoIP transmission, a retransmission request would be expected. An absence of a response identifies the transmission as voice and the presence of a retransmission request identifies the transmission as a potential transmission of unauthorized data.

In another embodiment of the invention, the stimulation includes introducing delay into the transmissions. The delay may trigger a retransmission request, but can also be used to identify VoIP transmission by the response from the caller at the receiving data processor 22. As an example, delaying portions of the transmission for an actual VoIP call will likely interfere with the speech and cause the callee to respond with words that indicate that caller cannot be understood. If there is no spoken response, the transmission can be identified as a potential unauthorized data transmission disguised as VoIP. Additionally or alternatively, voice recognition software can be used to identify expected words or phrases from a callee in response to delayed voice transmissions, such as, for example, “please repeat.” Other examples of delay include jitter or latency.

The stimulation can be randomly or systematically applied to transmissions within, from, and/or to the protected network. Alternatively, all transmissions, or at least all of certain types of transmissions such as VoIP or streaming video, can be stimulated. The stimulation of transmissions of this invention also can be successfully applied to encrypted transmissions. Stimulating encrypted transmissions provides a mechanism to determine the type or content of the data within the encrypted transmission, regardless of whether or not the transmission is authorized.

In one embodiment of this invention, the protected network monitors for the predicted response on the sending or forward channel 24 in FIG. 1. The middlebox 30 can monitor for a retransmitted payload on the sending channel. For example, in one embodiment, the stimulation is an alteration or deletion of data (e.g., a data packet) from the transmission. The altered or deleted data is copied and stored by the middlebox and used to compare to future data packets of the transmission or a second transmission from the sending data processor 20. If any packets match the altered or deleted data stored by the middlebox 30, then a retransmission is likely occurring and the network administrator can be signaled. Sampling windows, such as of a few seconds in length, can be established for such comparison, so as to reduce interference with the transmission. Desirably, there would be no stopping and little or no delaying of the transmission to perform the comparison of the data payloads. The data payloads are desirably compared asynchronously.

In addition or in the alternative, a return or back channel 25 can be monitored for the predicted response. In one embodiment of this invention, the back channel 25 can be monitored for a request for retransmission of all or a portion of a stimulated transmission. Where the transmission is stimulated to render hidden data, such as structured data, unusable, a request for retransmission on the back channel 25 would be expected. The request for retransmission is likely to be of a different size or type than the expected payloads on the back channel, such as being smaller in size, thereby facilitating detection of a back channel retransmission request.

The stimulation used in this invention can be implemented randomly or in a predetermined pattern of stimulation. Random stimulation can provide a predictable response of changing (e.g., reducing) the number of messages flowing and/or the time interval between messages on the back channel. For patterned stimulation, the predictable response is an expected patterned response that corresponds to the particular stimulation pattern. Placing a systematic pattern on the front channel can provide for a patterned flow of messages on the back channel. Patterned stimulations resulting in patterned responses also decrease false positives.

The stimulation and detection method of this invention can also be implemented for transmissions that utilized a packet acknowledgement system. In such packet acknowledgement systems, commonly used in Transmission Control Protocols (TCP), a lack of positive acknowledgment is coupled with automatic retransmission to guarantee reliability of packet transfers. This technique requires the receiver to respond with an acknowledgment message as it receives the data. The sender keeps a record of each packet or group of packets it sends, and waits for acknowledgment before sending the next packet. The sender also keeps a timer from when the packet was sent, and automatically retransmits a packet if the timer expires before an acknowledgement is received. The timer is needed in case a packet becomes lost or corrupt. Stimulating or altering random or patterned packets according to this invention desirably would leave an authorized multi-media transmission useable but any unintended data unusable. If the stimulated packets consistently receive no acknowledgement, and are thus being resent, then there is a possibility that the stimulation is the reason for the lack of acknowledgement, and that there is data within the transmission packets that is being corrupted. A security breach can be signaled by the network when the stimulated or altered packets are resulting in an unexpected number of retransmissions.

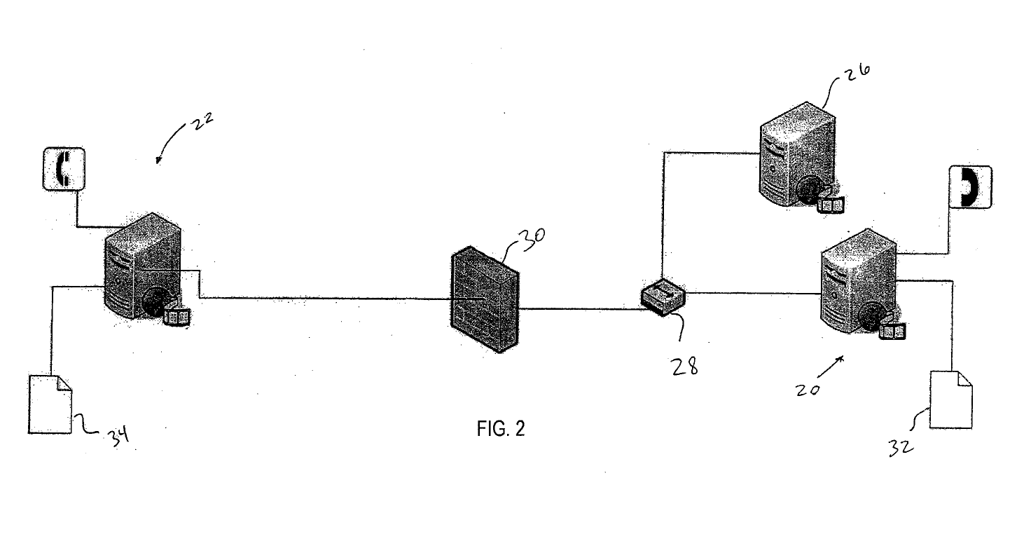

FIG. 2 is a simple schematic that illustrates the implementation of the method of one embodiment of this invention. In FIG. 2, a sending data processor 20, e.g., a SIP (Session Initiation Protocol) phone, is used to make a VoIP call to a receiving data processor 22. The sending data processor 20 is shown as part of a network including SIP proxy server 26, hub 28, and firewall middlebox 30.

Without implementing the method of this invention, a user of the sending data processor is able to send a data file 32 as an unauthorized or otherwise hidden transmission within an otherwise authorized VoIP call, to be received as data file 34 by the receiving data processor 22. Currently, firewalls and other security hardware or software generally cannot provide sufficient monitoring of the VoIP data transmission to detect for and/or filter out the unauthorized data file 32; as such an inspection would introduce delay and interfere with the communication of the transmission. Typically, a firewall will inspect only the headers of a VoIP transmission and not perform a deep packet inspection, thereby not noticing unauthorized data hidden in the packets.

In one embodiment of the method of this invention, the network transmission is altered to interfere with the unauthorized transmission and render the unauthorized transmission invalid to the receiving data processor. The alteration according to this invention renders the data file 32 invalid to the receiving computer 22, while the media content of the network transmission is still understandable by the receiving data processor 22. The alteration desirably includes changing data bits in the transmission, or either adding or deleting bits, and can be done by the firewall 30, or other similar middlebox hardware, such as a conference server, a gateway, a proxy or a router, or software executable thereon.

Internet standard protocols, such as without limitation, UDP and RTP, for the transport of real time data, such as voice and video, generally separate the data transmission into packets. Common data packets generally include a header at the beginning, a payload (data) area, and a trailer marking the end of the packet. In one embodiment of this invention, the network transmission is altered by adding, deleting, or changing data bits in the payload of one or more of the plurality of packets. These alterations can be random or selective, such as changing, deleting, or adding a packet after every predetermined number of packets along the network transmission. In one embodiment, adding packets to the network transmission is obtained by randomly or selectively duplicating packets or packet payload data along the network transmission.

Instead of attempting to actively inspect the data that flows through the port, the method of this invention damages or manipulates the data in a way that has little affect on the authorized media stream, but renders any unauthorized piggybacking computer data, databases, and/or executables unusable. The method of this invention is effective because, for example, voice and data have different receivers with different tolerances. Humans generally can tolerate errors and missing data packets, and data damaging according to this invention can go virtually unnoticed by humans. Computers, on the other hand, generally have a low tolerance for errors and missing data packets. For example, a computer executable typically will not run if damaged. The method of this invention damages and/or manipulates VoIP or other media stream data without a significant degradation to the signal intelligibility as perceived by the receiver, e.g., a human user.

In one embodiment of this invention, the authorized media content of the damaged and/or manipulated transmission can be repaired. Damaged voice and video can be reconstructed, or noises, e.g., clicks and pops, can be removed from an analog signal. For example, video data often has an overlap between adjacent video frames of about 95% redundancy. However, other (i.e., not streaming media having analog representation) computer data and executables generally follow no predictable patterns and cannot be reconstructed.

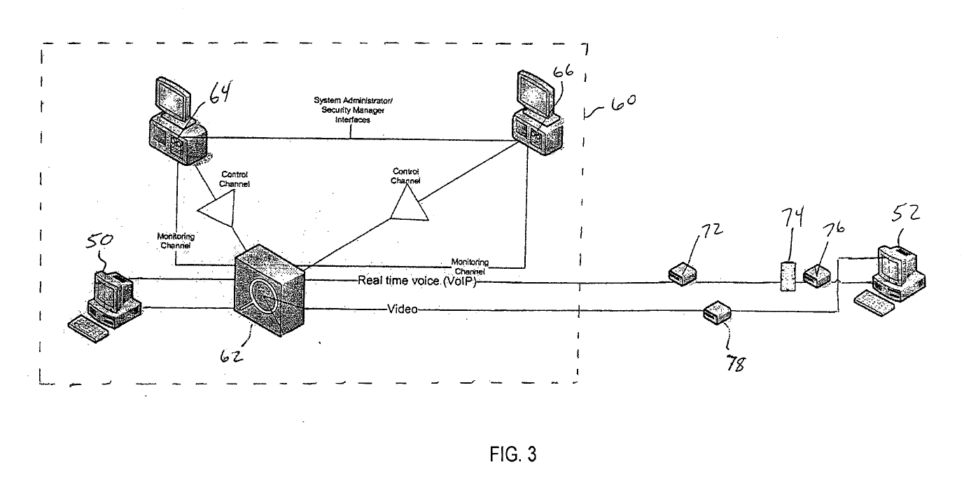

FIG. 3 is another schematic overview that illustrates the implementation of the method of another embodiment of this invention for securing against an unauthorized transmission within an authorized network transmission. In the embodiment shown in FIG. 3, a sending computer 50 is used to send an authorized network media transmission of at least one of voice and video over the Internet to a receiving computer 52. The transmission is divided for transmitting into a plurality of packets, e.g., RTP or UDP packets, each including at least a header and a payload. The user of the sending computer 50, or someone having access to the sending computer 50 and/or the transmission, hides an unauthorized item, e.g., data to be smuggled out of a company system, in the payload of the packets. Generally, the unauthorized item will also be partitioned into the packets, with each payload including a portion of the smuggled data.

In the embodiment shown in FIG. 3, the sending computer 50 is part of an intranet network system 60, such as, for example, a company or government network system. The system 60 includes a middlebox 62, as well as optional intrusion and extrusion detection system 64 and stream behavior analysis system 66, such as are known and available to those skilled in the art. The authorized media transmission is routed from the sending computer 50 to and through the middlebox 62, which is controlled by an administrator of the system 60. In one embodiment of this invention, the middlebox 62, which can be, for example, a firewall, conference server, gateway, proxy or router, alters the transmission, such as described above, to interfere with the unauthorized item and render the unauthorized item invalid to the receiving computer 52.

The middlebox 62 alters the transmission by selectively or randomly adding, deleting, or changing data bits in the payload of one or more of the plurality of packets. The altered media transmission leaves the middlebox 62 and is routed over the Internet to the receiving computer 52. In one embodiment of this invention, the receiving computer 52 can repair the altered authorized media transmission. In FIG. 3, a digital voice repairer 72 can be used to repair the voice stream based upon, for example, predictive redundancies of voice that are not present in the unauthorized data stream. Digital repair is performed before digital to analog conversion 74, but the same or similar result can be obtained by an analog voice repairer 76. Similarly, a video repairer 78, e.g., a digital video repairer, can repair video media streams based upon predictive redundancies in video streams that are not present in unauthorized data streams.

Of course, implementing the security measures of this invention would invite adaptations to circumvent the method. For example, upon receiving the altered unauthorized item within the otherwise authorized transmission, the receiving computer 52 may initiate a predictable response, such as a request to the sending computer 50 to retransmit the unauthorized item. Another possibility is where the sender and/or sending computer 50 are aware of the altering of the unauthorized item, and the sending computer 50 retransmits the unauthorized item at least once during the transmission. The purpose of both of these actions is to attempt to transmit all portions of the unauthorized item through more than one transmission. By retransmitting the unauthorized item, the middlebox 62 may not remove or otherwise affect the same bits of the unauthorized item. The receiving computer 52 receives all the data bits of the unauthorized item through more than one hidden transmission, and reconstructs the unauthorized item from the multiple incomplete or otherwise imperfect transmissions.

The system 60 desirably monitors for such data retransmission requests and/or disallows retransmissions of data. In one embodiment of this invention, the system monitors the authorized transmission for a retransmission request, such as described above, from the receiving computer 52 or a retransmission by the sending computer 50 and signals the administrator of system 60 of a potential unauthorized data transmission when the retransmission request or the retransmission is detected.

The middlebox 62, alone or in combination with the intrusion and extrusion detection system 64 and/or stream behavior analysis system 66, desirably monitors for retransmissions and/or requests therefore. As multimedia content doesn't typically use retransmissions or retransmission requests, these activities represent a predictable response when structured data is present in a VoIP call and can indicate that something other than multimedia including voice or video is present in the transmission.

The method of this invention can desirably be used in conjunction with other available data detection methods. For example, in one embodiment of this invention, a passive detection method, such as may be implemented by system 64, continually or periodically monitors VoIP transmissions to determine if any computer data or executables are being moved across a VoIP channel. If an unauthorized transmission is suspected, the VoIP transmission can be stimulated or altered according to this invention, or the level of altering can be increased. By increasing the alterations of the VoIP transmission, more interference in the voice signal may result. However, the interference is generally preferred over the alternative of, for example, the system 60 terminating the call. By reducing the need to terminate suspected calls, the method of this invention can reduce the harm of false positives on callers.

Thus, the invention provides a method for simply and efficiently securing against service fraud and/or theft of data through an authorized multimedia transmission, such as VoIP transmissions. By not performing deep packet inspection of the transmission for unauthorized add-ons before altering the transmission, this invention does not introduce appreciable unwanted delay and/or jitter to the media transmission. Also, the level of alteration can be adjusted, and can be implemented without causing appreciable degradation in the intended transmission.

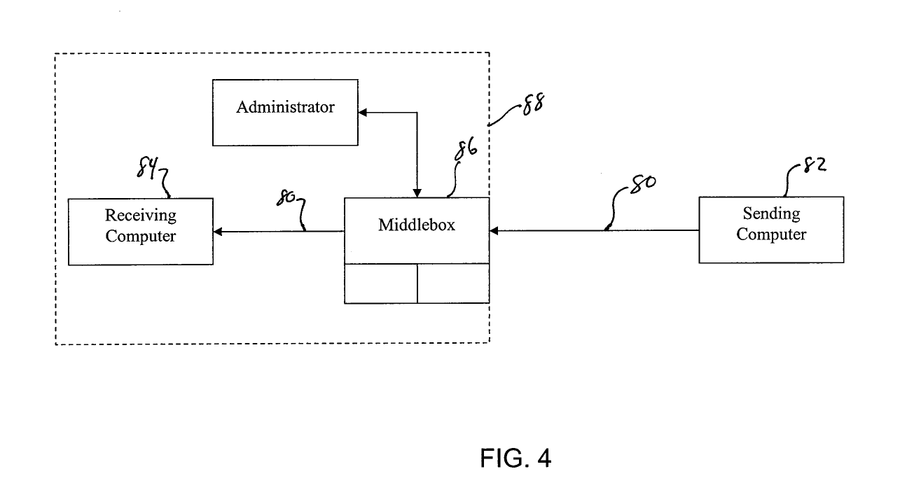

FIG. 4 is another schematic overview that illustrates the implementation of a method of another embodiment of this invention for securing against an unauthorized transmission within an authorized network transmission. In FIG. 4, the transmission 80 originates from an external sending data processor 82 and is sent to a receiving data processor 84 within protected network 88. The transmission is sent through middlebox 86, which stimulates the transmission 80 according to this invention. By altering or otherwise stimulating the transmission 80, any hidden or otherwise unauthorized data or programs can be corrupted and rendered unexecutable.

The method and apparatus of this invention thus provide a desirable barrier against malware, such as, for example, viruses, Trojan horses, and spy ware.

As discussed above, the method and apparatus of this invention corrupt and/or detect hidden data in otherwise expected and authorized transmissions. The method and apparatus of this invention can thus secure against unauthorized transmissions that are hidden from conventional behavior analysis detection tools. In one embodiment of this invention, however, network behavior analysis is used and applied to the method of this invention to further improve efficiency and reduce false positives.

Network behavior analysis (NBA) is a method of enhancing the security of a proprietary network by monitoring traffic and noting unusual actions or departures from normal operation. Conventional behavior analysis methods can be used to monitor the front and/or back channels. The information gathered from monitoring and learning the transmissions and responses for stimulated transmissions can be used to determine a type or frequency of stimulation for use in stimulating any given transmission. In one embodiment, the behavior analysis can be used to modify the stimulation of a given transmission during the transmission. The stimulus modification can be one of type or frequency, or any other modification. Modifying the stimulus based upon observed response can be used to reduce false positives.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method of determining a type or content of a transmission from a sending data processor to a receiving data processor, wherein at least one of the sending data processor or the receiving data processor is within a protected network, the method comprising:
stimulating one of the protected network or the transmission from within the protected network to elicit a predictable response from the receiving data processor;
determining the type or content of the transmission based upon an observation or absence of the predictable response.

2. The method according to claim 1, wherein the transmission is encrypted.

3. The method according to claim 1, wherein the stimulating comprises a predetermined stimulation pattern and the predictable response comprises a patterned response corresponding to the predetermined stimulation pattern.

4. The method according to claim 1, further comprising modifying the stimulating based upon the observation or absence of the predictable response.

5. The method according to claim 1, wherein stimulating the protected network comprises introducing noise into transmissions from or within the protected network.

6. The method according to claim 1, wherein stimulating the protected network comprises delaying at least portions of transmissions from or within the protected network.

7. The method according to claim 1, wherein determining the type or content of the transmission comprises monitoring a back channel.

8. The method according to claim 7, further comprising monitoring the back channel for speech data from the receiving computer.

9. The method according to claim 1, further comprising determining a type or frequency of stimulation based upon information gathered in observing a forward channel of the protected network.

10. The method according to claim 1, further comprising determining a type or frequency of stimulation based upon information gathered in observing a back channel of the protected network.

11. The method according to claim 1, wherein stimulating the transmission comprises altering the transmission.

12. The method according to claim 11, further comprising storing a copy of a portion of the transmission that is altered and comparing the copy to further portions of the transmission or a second transmission to determine if the further portions of the second transmission include a retransmission of the portion of the transmission that is altered.

13. The method according to claim 11, further comprising:
monitoring for a transmission response from the sending data processor or the receiving data processor; and
determining the type or content of the transmission based upon the transmission response from the sending data processor or the receiving data processor.

14. The method according to claim 13, further comprising altering the transmission in a pattern and monitoring for a patterned transmission response.

15. The method according to claim 13, wherein the monitoring for the transmission response comprises monitoring for a retransmission request or a retransmission on a back channel of one of the sending data processor or the protected network.

16. The method according to claim 13, wherein the monitoring for the transmission response comprises monitoring for a retransmission on a sending channel of one of the sending data processor or the protected network.

17. The method according to claim 1, wherein the stimulating occurs at a middlebox of the protected network which is disposed between the sending data processor and the receiving data processor.

18. A computer readable medium encoded with instructions executable on a middlebox of the protected network for performing a method comprising:
stimulating one of the protected network or a transmission from within the protected network to elicit a predictable response from the receiving data processor;
determining the type or content of the transmission based upon an observation or absence of the predictable response.

19. An apparatus for determining a type or content of a transmission from a sending data processor to a receiving data processor, the apparatus comprising:
a processor; and
a storage medium in combination with the processor and storing a program for controlling the processor;
the processor operative with the program to introduce a stimulation to one of the protected network or a transmission from within the protected network to elicit a predictable response from the receiving data processor.

20. The apparatus according to claim 19, wherein the processor is further operative with the program to determine the type or content of the transmission based upon an observation or absence of the predictable response.

21. The apparatus according to claim 20, wherein the device comprises a middlebox selected from the group consisting of a firewall, conference server, gateway, proxy or router.

22. The apparatus according to claim 20, wherein the stimulation comprises a predetermined stimulation pattern and the predictable response comprises a patterned response corresponding to the predetermined stimulation pattern.

23. The apparatus according to claim 20, wherein the storage medium further stores a program operative with the processor for modifying the stimulation based upon the observation or absence of the predictable response.

24. The apparatus according to claim 20, wherein the storage medium further stores a program operative with the processor for monitoring a back channel to determine the type or content of the transmission.
